(19) United States
(12) Patent Application Publication
(10) Pub. No.: US 2005/0116532 A1
(43) Pub. Date: Jun. 2, 2005

(54) Electrohydraulic brake system and method for operating the same

(76) Inventors: Ralf Trutschel, Ilmenau (DE); Klaus Augsburg, Arnstadt (DE)

Correspondence Address: FORD GLOBAL TECHNOLOGIES, LLC., SUITE 600 - PARKLANE TOWERS EAST, ONE PARKLANE BLVD., DEARBORN, MI, 48126, US

(21) Appl. No.: 10/468,961

(22) PCT Filed: Feb. 21, 2002
(86) PCT No.: PCT/EP02/01834

(30) Foreign Application Priority Data
Feb. 22, 2001 (DE) 101 08 589.3

(51) Int. Cl. B60T 7/00; B60T 13/74

(52) U.S. Cl. 303/3; 303/15; 188/156

(57) ABSTRACT

The invention relates to an electrohydraulic brake system in which, in a normal operating mode, a pedal cylinder (1) which is coupled to a brake pedal (16) can be acted on either by a high-pressure reservoir (12) or a low-pressure reservoir (13) via an electrovalve (4). Likewise, a brake cylinder (2) which is coupled to a brake device (17) can be coupled either to the high-pressure reservoir (12) or the low-pressure reservoir (13) via an electrovalve (7). If there is a fault, by switching over electrovalves (3, 5, 6), the system is changed over into a safety mode in which the pedal cylinder (1) and the brake cylinder (2) are coupled directly hydraulically. In order to ensure a defined volume of hydraulic fluid in the hydraulic path (13) here, an additional cylinder (8) is provided whose spring-loaded side which expands in the safety mode can carry off excess hydraulic fluid from the brake cylinder (2). In addition, hydraulic fluid can be removed from the low-pressure reservoir (13) via a nonreturn valve (11).

The invention relates to an electrohydraulic brake system containing a pedal cylinder which is coupled to a brake pedal, a brake cylinder which is coupled to brake devices and at least one valve which, in a safety mode, can bring about a hydraulic path with a direct connection between the pedal cylinder and brake cylinder. In addition, the invention relates to a method for operating such a brake system.

Electrohydraulic brake systems are known, for example, from WO 00/68053. They have a high-pressure reservoir and a low-pressure reservoir for a hydraulic fluid as well as electromagnetic valves (“servovalves”), the activation of which can cause the aforesaid reservoirs to be selectively coupled to a brake cylinder in order to generate a brake pressure in the brake devices (disk brakes, drum brakes or the like). The braking force can thus be set independently, of the pedal position of the brake pedal and does not have to be generated by means of the physical force of the driver. However, in order to give the driver a customary feedback sensation when the brake pedal is activated, systems have been developed with electrohydraulic activation of the pedal travel. In these systems, the brake pedal is coupled to a pedal cylinder which may be of one-sided or two-sided design and whose working volume or volumes can be coupled either to a high-pressure reservoir or a low-pressure reservoir by a controller via a further electromagnetic valve.

Furthermore, it is known to equip electrohydraulic brake systems with a safety system which, when there is a fault—such as in particular failure of the pressure in the high-pressure reservoir—permits the brake to be activated. For this purpose, suitable switching of electromagnetic valves ensures that a hydraulic path containing two corresponding working volumes of pedal cylinder and brake cylinder is brought about so that a direct hydraulic active connection is produced between the brake pedal and the brake devices. However, the problem with these systems is that the changeover into the safety mode can take place at a time at which the pistons in the pedal cylinder and brake cylinder are in positions where they do not correspond so that there is too little or too much hydraulic fluid in the hydraulic path for normal hydraulic operation. If, for example, there is too much hydraulic fluid in the hydraulic path, the brake cylinder piston cannot assume its zero position. The safety system thus indeed guarantees braking at any time, but not the release of the brakes.

Against this background, the object of the present invention has been to make available an electrohydraulic brake system and a method for operating it which, in the safety mode, ensures the widest possible functional range of the brake system in each case.

This object is achieved by means of a brake system having the features of claim 1 and by means of a method having the features of claim 7. Advantageous refinements are contained in the subclaims.

The electrohydraulic brake system according to the invention contains a “pedal cylinder” which is coupled to a brake pedal, and a “brake cylinder” which is coupled to brake devices. In addition, it contains at least one preferably electrically activated valve which can be activated in such a way that, in a safety mode, it can bring about a hydraulic path with a direct hydraulic connection between the pedal cylinder and brake cylinder. According to the definition, the hydraulic path includes the connecting line and the coupled working volumes of the pedal cylinder and brake cylinder. In the hydraulic path it is possible, in particular, for the working volume, which is compressed when the brake pedal is activated, of the pedal cylinder to be coupled to the working volume, which expands when the brake is applied, of the brake cylinder. The brake system is defined by the fact that it has a balancing device with which, in the safety mode, a defined volume of hydraulic fluid can be brought about in the hydraulic path.

The fact that a defined volume of hydraulic fluid is made certain by the balancing device ensures that a reliable function with a broad working range is achieved between the brake pedal and brake devices when there is direct hydraulic coupling. In particular permanent blocking of the brakes cannot occur as a result of an excess of hydraulic fluid.

According to one preferred refinement of the brake system, it has an additional cylinder with a spring-loaded piston, that working volume of the additional cylinder which expands under the effect of the spring being capable of being coupled to the hydraulic path by means of preferably electrically activated valve. Such coupling may take place, in particular, at the changeover into safety mode, after which the working volume, which expands under the effect of the spring, of the additional cylinder can take off excess hydraulic fluid from the hydraulic path. It is advantageous here that this withdrawal of hydraulic fluid is brought about as a result of the expansion of a spring and is thus independent of the hydraulic pressure which may have dropped during a changeover into the safety mode.

According to one development of the refinement mentioned above, the working volume, which is compressed under the effect of the spring, of the additional cylinder can be coupled to a high-pressure reservoir via a preferably electrically activated valve. This coupling may be brought about here in particular outside the safety mode so that high pressure then prevails in the aforesaid working volume and causes the piston of the additional cylinder to be displaced with compression of the spring. In this way it is ensured that during a possible changeover into the safety mode the spring is in the compressed state and can therefore ensure the desired expansion of the spring-end volume.

In one preferred refinement of the brake system, the hydraulic path is coupled via a nonreturn valve to a low-pressure reservoir with hydraulic fluid. In this way it is possible to bring about a situation in which not less than a predefined quantity of hydraulic fluid is located in the hydraulic path. Should this in fact be the case at the beginning, as a result at some time a situation is produced in which a lower pressure prevails in the hydraulic path than in the low-pressure reservoir. However, at this time, the nonreturn valve opens and thus brings about an inflow of hydraulic fluid to the required extent.

Furthermore, the brake system may contain a low-pressure reservoir for hydraulic fluid, to which reservoir, in the safety mode, the respectively second sides of a two-sided pedal cylinder are coupled to a two-sided brake cylinder and/or a two-sided additional cylinder. Such coupling brings about defined force relationships and a system-wide equalization of volume of the hydraulic fluid.

In addition, the pedal cylinder and/or the brake cylinder can be coupled to a (further) preferably electrically activated valve via which, outside the safety mode, the cylinder working volumes can either be connected to a low-pressure reservoir or a high-pressure reservoir. In this way, the position of the piston and movement of the piston of the cylinders can be controlled electrically in a desired way.

The invention also relates to a method for operating an electrohydraulic brake system, the brake system being capable of is being configured in particular in the way explained above. The brake system contains a pedal cylinder which is coupled to a brake pedal and a brake cylinder which is coupled to brake devices, a hydraulic path with a direct connection between the pedal cylinder and brake cylinder being brought about at the changeover into a safety mode. The method is defined by the fact that in the safety mode a defined volume of hydraulic fluid is brought about in the hydraulic path of the pedal cylinder and brake cylinder. The result of this is that the brake system also has the widest possible working range in the safety mode.

In particular in the method, hydraulic fluid can be sucked out of the brake cylinder at the changeover into the safety mode until the piston of said brake cylinder has reached its home position. This home position of the piston constitutes a defined state which is to be assumed when the brake devices are completely released.

In addition, hydraulic fluid can be fed to the hydraulic path if the pressure in the hydraulic path drops below a predefined pressure. This provides an equalization of volume if there should be too little hydraulic fluid in the hydraulic path at the start of the safety mode as a result of the position of the pistons of the pedal cylinder and brake cylinder which happens to be present.

Furthermore, it is preferred if, outside the safety mode, high pressure or low pressure is applied to the pedal cylinder and/or the brake cylinder controlled via preferably electrically activated valves. In this way, servofunctions of the brake system can be generated.

The invention is explained in more detail below by way of example using the figures, in which:

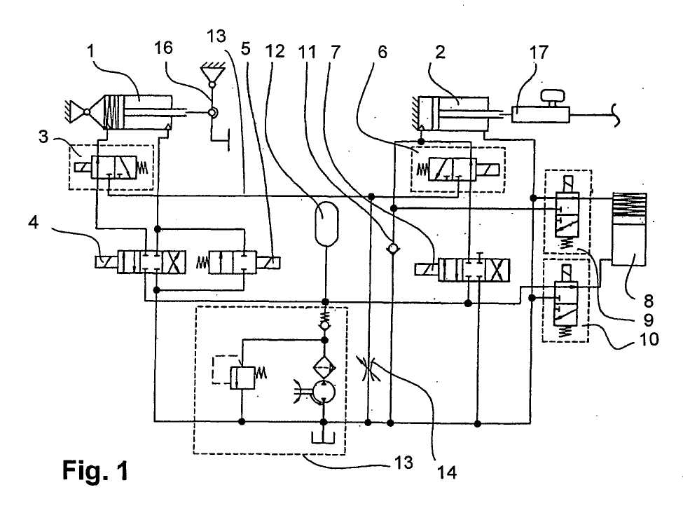

FIG. 1 shows a brake system according to the invention, and

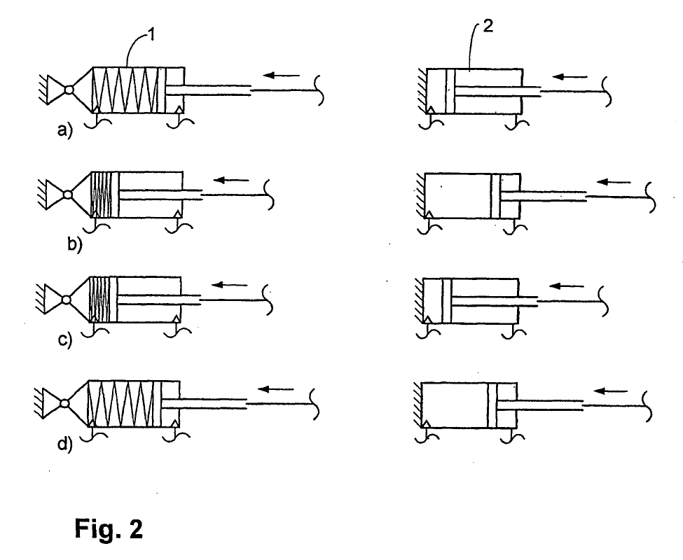

FIGS. 2a-d show various initial states of the pedal cylinder and brake cylinder at the changeover into a safety mode.

FIG. 1 is a schematic view of the circuit diagram of an electrohydraulic brake system according to the invention, the illustrated position of the valves corresponding to the normal operating mode in the “regulated mode”. The brake system contains a pedal cylinder 1 whose piston is coupled to a brake pedal 16. A spring force which forces the piston into a home position (inactivated brake pedal) acts on the piston. The pedal cylinder 1 is embodied as a double-acting cylinder whose two reciprocal working volumes can be coupled either to a high-pressure reservoir 12 or low-pressure reservoir 13 for hydraulic fluid via an associated electromagnetic servovalve or proportional valve 4 in accordance with the predefined values of a controller (not illustrated). In this way, a force can be exerted selectively on the piston of the pedal cylinder 1 and thus on the brake pedal 16 by activating the servovalve 4.

Furthermore, the brake system contains a brake cylinder 2 which is coupled to a brake device 17 in order to generate a braking force at the wheels. The brake cylinder 2 is also of double-acting design with two reciprocal working volumes in the example illustrated, the one working volume being capable of being connected either to the high-pressure reservoir 12 or the low-pressure reservoir 13 via a servovalve 7 in accordance with the predefined values of a controller. The other working volume of the brake cylinder 2 is connected directly to the low-pressure reservoir 13 in the example illustrated.

With a brake system of the design described above, it is possible to implement a normal electrohydraulic braking operating mode in which electrohydraulic activation of the pedal travel can take place by means of the pedal cylinder 1, and electrohydraulic activation of the brakes can take place by means of the brake cylinder 2.

In order to ensure that the brakes are activated even in the event of a fault, such as for example when the high-pressure reservoir 12 fails, the brake system which is illustrated in FIG. 1 can be changed into a so-called safety mode. In this safety mode, the electrovalves 3, 5 and 6 are changed into the respective other state (not illustrated) so that the servovalves 4 and 7 are disconnected from the pedal cylinder 1 and the brake cylinder 2. In the safety mode, a direct connection is brought about between the sides of the pedal cylinder 1 and brake cylinder 2 which face away from the piston rods, via a first electrovalve or solenoid valve 3 and a second electrovalve 6. The connection between the respective working volumes of the cylinders 1 and 2 including these volumes themselves is referred to below as “hydraulic path 13”.

The side of the pedal cylinder 1 which faces the piston rods is coupled directly to the low-pressure reservoir 13 in the safety mode by the switching over of a third electrovalve 5, the side of the brake cylinder 2 which faces the piston rods also being coupled to said low-pressure reservoir 13. Between the two cylinders 1 and 2 there must be at least one assembly is which throttles the volume flow between the two cylinders.

A direct hydraulic coupling between the two cylinders is brought about by means of the above-described hydraulic path 13 between the pedal cylinder 1 and brake cylinder 2, so that the brake device 17 can be activated by a pressure on the brake pedal 16.

As the pedal cylinder 1 and the brake cylinder 2 operate independently of one another in the regulated mode, their pistons may be in various positions at the changeover into the safety mode (switching over of the valves 3, 5, 6). The most important possible cases are illustrated in FIGS. 2a-2d.

In FIG. 2a, the piston of the pedal cylinder 1 is in the respective home position (no activation of the brake), as is the piston of the brake cylinder 2. On the other hand, in FIG. 2b, the piston of the pedal cylinder 1 is at the respective stop (maximum activation of the brake), as is that of the brake cylinder 2. Both FIGS. 2a, 2b thus show a hydraulically balanced system for the state of pressure release and pressure loading.

In FIG. 2c, the piston of the pedal cylinder 1 is at its stop (brake pedal depressed), and the piston of the brake cylinder 2 is in its home position (brake device loose). If the changeover into the safety mode takes place in such a case, there is too little hydraulic fluid in the hydraulic path 13.

FIG. 2d shows the other extreme in which the piston of the pedal cylinder 1 is in its home position (brake pedal released) and the piston of the brake cylinder 2 is in its stop position (brake devices applied), so that at the change-over into the safety mode there is an excess of hydraulic fluid in the hydraulic path.

The cases illustrated in FIGS. 2c and 2d delimit the function of the brake system in the safety mode as, when there is a lack of hydraulic fluid, sufficient activation of the brakes is no longer ensured, and when there is an excess of hydraulic fluid the brakes can no longer be released satisfactorily.

In order to avoid the described problems, according to the invention a balancing device is proposed with which the volume of the hydraulic fluid in the hydraulic path 13 can be set to a desired value at the start of the safety mode. In order to achieve this, the system contains a double-acting additional cylinder 8 (cf. FIG. 1) whose piston is prestressed by means of a spring. The balancing of that working volume which tends toward expansion (“spring space”) under the effect of the spring is switched by means of an electrovalve 9 in such a way that in the regulated mode (FIG. 1) it is connected to the low-pressure reservoir 13, and in the safety mode (position of the valve 9 not illustrated in FIG. 1) to the hydraulic path 13 at a point between the throttle and brake cylinder 2. The connection of the complementary working volume of the additional cylinder 8 is switched via a second electrovalve 10 in such a way that said second electrovalve 10 is connected to the high-pressure reservoir 12 in the regulated mode (FIG. 1) and to the low-pressure reservoir 13 in the safety mode (position of the valve 10 not illustrated in FIG. 1).

Owing to the switching of the additional cylinder 8 described above, a pressure drop is brought about from the working volume facing away from the spring to the spring space in the regulated mode so that the piston of the additional cylinder 8 moves in this direction as far as its stop and remains there during the regulated mode. The spring is prestressed in this way.

If the system changes over from the regulated mode into the safety mode, the pressure difference in the additional cylinder 8 changes the direction as a result of the switching over of the electrovalves 9 and 10. Owing to the effect of the spring in the additional cylinder 8, the spring space expands at the same time. If the piston of the brake cylinder 2 is not in its home position at the changeover into the safety mode—similarly to in FIG. 2d—the volume which is expelled by it will flow off into the spring space of the additional cylinder 8 until the piston of the brake cylinder 2 has assumed its zero position or home position. Excess hydraulic volume is carried away in this way.

The brake system also contains a nonreturn valve 11 which connects the hydraulic path 13 to the low-pressure reservoir 13 at a point between the throttle and brake cylinder 2, the through-flow direction of the nonreturn valve 11 running from the low-pressure reservoir 13 to the hydraulic path 13. The nonreturn valve 11 opens when the piston of the brake cylinder 2 has reached its home position, but the piston of the additional cylinder 8 is not yet at its stop. As a result of the opening of the nonreturn valve 11, the spring space of the additional cylinder 8 can then be filled with hydraulic fluid until the piston reaches its stop. The volume of the additional cylinder 8 which is expelled on the side facing away from the spring flows off into the low-pressure reservoir 13 here.

If the piston of the pedal cylinder 1 is not at its home position stop (cf. FIG. 2c) at this time, the nonreturn valve 11 will open at the first pressure release and remain open until the piston of the pedal cylinder 1 has also reached its zero position or home position. The brake system is then volumetrically balanced.

In the case of a fault, the brake system according to the invention is changed over, by switching over the electro valves 3, 5 and 6, into a safety mode in which the pedal cylinder 1 and the brake cylinder 2 are coupled directly hydraulically. In order to ensure a defined volume of hydraulic fluid in the hydraulic path here, the additional cylinder 8 is provided, the spring-loaded side of which which expands in the safety mode can carry off excess hydraulic fluid from the brake cylinder 2. Furthermore, hydraulic fluid can be extracted from the low-pressure reservoir 13 via a nonreturn valve 11.

1. An electrohydraulic brake system, containing
a) a pedal cylinder (1) which is coupled to a brake pedal (16),
b) a brake cylinder (2) which is coupled to brake devices (17),
c) at least one valve (3, 6) which is preferably electrically activated and which, in a safety mode, can bring about a hydraulic path (13) with a direct connection between the pedal cylinder (1) and brake cylinder (2),
wherein the brake system has a balancing device (8, 9, 10, 11) with which, in the safety mode, a defined volume of hydraulic fluid can be brought about in the hydraulic path (13).

2. The electrohydraulic brake system as claimed in claim 1, wherein the balancing device contains an additional cylinder (8) with a spring-loaded piston, the working volume, which expands under spring effect, of the cylinder being capable of being coupled to the hydraulic path (13) in the safety mode by means of a preferably electrically activated valve (9).

3. The brake system as claimed in claim 2, wherein, outside the safety mode, the working volume, which is compressed under spring effect, of the additional cylinder (8) can be coupled to a high-pressure reservoir (12) via a preferably electrically activated valve (10).

4. The brake system as claimed in one of claims 1 to 3, wherein the hydraulic path (13) is coupled to a low-pressure reservoir (13) via a nonreturn valve (11).

5. The brake system as claimed in one of claims 1 to 4, wherein the latter has a low-pressure reservoir (13) to which, in the safety mode, the respective second sides of the pedal cylinder (1), brake cylinder (2) and/or additional cylinder (8) are coupled.

6. The brake system as claimed in one of claims 1 to 5, wherein the pedal cylinder (1) and/or the brake cylinder (2) is/are coupled to a preferably electrically activated valve (4, 7) via which, outside the safety mode, the cylinder volumes can be connected optionally to a low-pressure reservoir (13) or to a high-pressure reservoir (12).

7. A method for operating an electrohydraulic brake system, in particular a brake system as claimed in one of claims 1 to 6, containing
a) a pedal cylinder (1) which is coupled to a brake pedal (16),
b) a brake cylinder (2) which is coupled to brake devices (17),
in which case, at the changeover into a safety mode, a hydraulic path (13) is brought about with a direct connection between the pedal cylinder (1) and brake cylinder (2), wherein, in the safety mode, a defined volume of hydraulic fluid is brought about in the hydraulic path (13).

8. The method as claimed in claim 7, wherein, at the changeover into the safety mode, hydraulic fluid is sucked out of the brake cylinder (2) until its piston has reached its home position.

9. The method as claimed in claim 7 or 8, wherein hydraulic fluid is fed to the hydraulic path (13) if the pressure there drops below a predefined pressure.

10. The method as claimed in one of claims 7 to 9, wherein, outside the safety mode, high pressure or low pressure is applied to the pedal cylinder (1) and/or brake cylinder (2) under the control of electrovalves (4, 7).
